(19) United States
(12) Patent Application Publication
(10) Pub. No.: US 2026/0098818 A1
(43) Pub. Date: Apr. 9, 2026

(54) SENSOR DEVICE

(71) Applicant: Liverpool John Moores University, Liverpool (GB)

(72) Inventors: Simone Dürr, Thingwall (GB); Andy Shaw, Aughton, Lancashire (GB); Karin Brenda Moejes, Nairobi (KE)

(21) Appl. No.: 19/125,922

(22) PCT Filed: Nov. 1, 2023
(86) PCT No.: PCT/GB2023/052849

§ 371 Date: Apr. 30, 2025

(30) Foreign Application Priority Data
Nov. 1, 2022 (GB) 2216217.6

(51) Int. Cl. G01N 22/00

(52) U.S. Cl. CPC G01N 22/00

(57) ABSTRACT

A sensing device configured for use in detecting biofouling adhered to a substrate, a method of detecting biofouling and a method of manufacturing a sensing device for detecting biofouling are disclosed. The methods and systems comprise a sensing device configured for use in detecting biofouling adhered to a substrate, the device comprising a sensing component. The sensing component comprises an electromagnetic wave sensor, the substrate and the electromagnetic wave sensor may be coupled to the substrate so as to be able to detect biofouling on the substrate.

The present disclosure relates to a sensing device configured for use in detecting biofouling adhered to a substrate, a method of detecting biofouling and a method of manufacturing a sensing device for detecting biofouling.

### BACKGROUND

The universal and ancient issue of biofouling is known to cause both financial and environmental costs with the occurrence of fuel penalties, damage to vessels, damage and failure of vessels, structures, infrastructure and equipment, greenhouse gas emissions, introduction of non-native or invasive alien species (IAS) species and spread of disease. Research, development and investment into managing and tackling these issues is focused on a few main strategies such as antifouling measures, cleaning and removal methods, implementation of regulations, and visual inspections.

Biofouling is defined as the colonisation process of a solid surface (living or dead) by sessile organisms, this essentially makes these organisms hitchhikers as they adhere to the hulls of ships. In order to adhere to the hull, the biofouling process may be generally divided into five main stages which may occur one after the other, overlap or even concurrently. Biofouling organisms are further split into two larger groups of microfoulers and macrofoulers, the prior of which creates a biofilm (or slime) that in turn usually facilitates the attachment of the larger macrofoulers (e.g. tubeworms, barnacles, macroalgae and mussels) to initiate a highly dynamic process. However, a biofilm is not necessarily needed for the formation of macrofouling and some invertebrate larvae are able to settle permanently on clean surfaces within an hour, quicker than the colonisation by some prokaryotic bacteria.

The diverse and dynamic biofouling community may in turn impact other environments to which they may be alien; the anthropogenic activities of shipping may introduce new, non-native and sometimes invasive species, which would not have been introduced to a new environment otherwise. In order to enable effective biosecurity and husbandry, maritime industries need to be able to determine the amount of biofouling and the time of removal. Current regulations include voluntary guidelines from the International Maritime Organisation (IMO) (International maritime organisation, 2011), while in specific countries mandatory regulations for removal of biofouling from hulls were introduced, with New Zealand having specific thresholds for broad taxonomic groups. These regulations are generally enforced in the form of underwater inspections and cleaning by divers and/or scheduled (or even unscheduled) dry docking for removal and re-application of the antifouling coating. Biofouling on ships poses a biosecurity threat with the possible introduction of non-native marine species. Teams of commercial divers are supervised by qualified marine biologists to carry out a visual inspection of the hull, resulting in high costs and occupational health and safety hazards for the divers involved. Remotely Operated Vehicles (ROVs) or Autonomous Underwater Vehicles (AUVs) may accompany the divers or operate alone and are equipped with a variety of technologies such as lights, cameras, acoustic systems, transmission of data, status updates, conductivity-temperature-depth sensors and sonar systems.

The longstanding relationship between the maritime industry and biofouling resulted in billions of dollars in expenses per annum. The costs are incurred due to hull cleaning or grooming, application of antifouling coatings, inspections, corrosion damage, structure, infrastructure and equipment failure, excess fuel consumption and dry-docking. The subsequent problems are caused by the release of millions of tons of carbon dioxide and the transportation of non-native species or IAS species and pathogens. The mounting economic and environmental pressures for the shipping industry to address biofouling and to streamline its management are intersected with the need for an efficient detection system. There is also an increasing demand by countries for vessels to quantify and carefully manage biofouling on ships entering their waters.

There are currently no systems or methods for real-time and in situ detection of biofouling in the maritime industry. The maritime industry is in need of an efficient biofouling monitoring system and antifouling solution that lies within the constraints set out by the International Maritime Organisation (IMO). Application of bioinspired microtopographies, as well as other engineered microtopographies, as an antifouling technology may offer an alternative to toxic biocides, microplastics, or additive oils (e.g. silicone oils).

A system or method for real-time and in situ detection of biofouling may allow for a streamlined and efficient antifouling strategy, reduce the risk of transporting IAS, reduce costs associated with increased biofouling and reduce greenhouse gas emissions from shipping, saving time, money and reducing the environmental impact. Moreover, as regulations are shown to restrict the acceptable level of biofouling on ships, clear and quantifiable biofouling regulations are enforced in some countries that must be upheld. There may be additional advantages of a sensor which could be specifically located and removed, particularly in niche areas which pose the risk of introducing IAS.

A sensory antifouling surface in the maritime industry may be able to address the need for detection of biofouling accumulation, with the capability of doing so in real-time (in situ). In view of the foregoing, it is desirable to provide new methods and sensors for detecting biofouling.

### SUMMARY OF THE DISCLOSURE

According to a first aspect of the present invention, there is provided a sensing device configured for use in detecting biofouling adhered to a substrate. The device comprises a sensing component comprising an electromagnetic wave sensor and the substrate. The electromagnetic wave sensor is able to detect biofouling on the substrate. The sensor device may be for use in detecting biofouling in an environment where biofouling may occur, for example a marine environment or a freshwater environment.

Preferably, the electromagnetic wave sensor is coupled to the substrate so as to be able to detect biofouling on the substrate or is on or embedded in the substrate so as to be able to detect biofouling on the substrate.

This sensor is contactless, because the actual sensor itself is associated with or coupled to the surface so as to be able to detect biofouling on the substrate, and the actual electromagnetic wave sensor components do not contact the surface of the substrate on which biofouling will settle and the water where biofouling will settle down from, or any other surface from where biofouling may grow towards or onto the substrate. This means that the sensor device has a very long life time, limited only by the electronic components or the corrosion of the substrate itself. The sensor device has a non-specific nature, as has been demonstrated with a model organism so as to be able to detect all types of biofouling.

Such a sensor is demonstrated herein to be capable of use with a range of substrates. This allows for widespread use with varying surfaces including available antifouling substrates, which may have coatings, and with common materials in the maritime industries. This was demonstrated for example with silicone, whose higher relative permittivity may be appropriate to allow for a sufficient reduction in the wavelength for detection of biofouling,. This means that the substrate may be a part of where the biofouling may occur, for example incorporated into a ship's hull, ballast or sea chest, or a separate device comprising the substrate may be coupled to, attached to or located in/on a desired location.

The sensor devices as described herein can be developed in cost-effective processes, and can be made using scalable technologies including print screening, ink-jet printing and photolithography.

Such a sensor device may be used in “predictive maintenance” (where it is possible to pinpoint issues and predict when and where they may occur.). Such sensors are able to generate vast amounts of data for records and regulation compliance, monitoring and control, prediction of failures and trigger maintenance, and increase information flow and responsiveness

Currently the maritime industry lags behind with no sensors presently available to detect biofouling in real-time and in situ. Utilisation of such a sensor device may allow for monitoring of biofouling development without the risks and costs associated with divers, ROVs or dry-docking as well as to assist regulatory authorities in monitoring compliance and maintenance of vessel records. With the ability to monitor biofouling, there may be an improvement in biofouling control with targeted, regular, and gentle hull cleaning. In turn, this will reduce biofouling accumulation, particularly in niche areas, which may decrease the risk of introducing IAS and facilitate in maintaining the durability of antifouling coatings to allow for a long-lasting antifouling capability. Furthermore, a reduction in biofouling on the hull surface will reduce the associated drag penalties and therefore decrease engine stress, costs, fuel consumption and greenhouse gas emissions.

Preferably, the electromagnetic wave sensor is planar.

Preferably, the electromagnetic wave sensor comprises at least one electrode. Preferably, at least one electrode comprises gold.

Preferably, the electromagnetic wave sensor comprises a plurality of electrodes arranged in an interdigitated electrode array.

The study highlights the effect of IDE numbers and geometry on sensing capacity of the EMW sensors whereby a sensor was demonstrated as not being impacted by the orientation of the panels nor the placement of the M. edulis byssal plaques. Furthermore, the non-specific surface capacity of the sensor demonstrated herein allowed it to function with the Nylon 6, Silicone and PVC whereby detection of M. edulis byssal plaques on the surface was possible and the reduced number of byssal plaques observed with Silicone highlight possible antifouling or foul-release properties of the material.

In the present study, the IDE geometry with relatively small dimensions and an increased number of electrodes demonstrated a localised electromagnetic field with high sensitivity.

Preferably, the interdigitated array comprises at least one pair of fingers. Preferably, the interdigitated array comprises at least three pairs of fingers. Preferably, the interdigitated array comprises at least two separated sets of three pairs of fingers. Preferably, the interdigitated array comprises at least eight pairs of fingers. Preferably, the interdigitated array comprises at least nine pairs of fingers.

Preferably, wherein the substrate is non-metallic. Preferably the substrate is a plastic, polymer or composite. Preferably, the substrate comprises polyvinylidene difluoride, polycaprolactam, silicone, polyvinyl chloride, and/or polytetrafluoroethylene.

Preferably, the electromagnetic wave sensor is configured to operate in a frequency range of about 1.5 to 7 GHz.

Preferably, the electromagnetic wave sensor is located on or embedded in the opposite surface of the substrate to the surface of the substrate on which the biofouling will occur, preferably wherein in the device the electromagnetic wave sensor is not exposed to any water or biofouling.

Preferably, the substate is at least 0.1 mm thick, preferably wherein the substate is between 0.1 mm and 5 mm.

Preferably, the sensing device further comprises circuitry for generating a microwave signal to transmit to the electromagnetic wave sensor, preferably wherein the signal is in a frequency range of about 1.5 to 7 GHz.

Preferably, the sensing device further comprises a detector to detect a reflected, backscattered or returned microwave signal frequency from the sensing component.

Preferably, the sensing device further comprises a controller to compute the reflected microwave signal frequency from the substrate and calculate a level of biofouling on the substrate or percentage of biofouling of a sensed area.

Preferably, the device is suitable for use in an environment where biofouling may occur.

Preferably, the device is coupled to or is part of something on which biofouling may occur, preferably the something on which biofouling may occur is a sea vessel, boat, submarine, ship, underwater cable, oil rig, platform, buoy, fishing net or fishing apparatus, underwater structure, energy generator, pipeline, waste water processing facility, telecom apparatus, marine instrument, underwater recording apparatus, aquaculture infrastructure and equipment, monitoring stations and equipment, cable, link station, ROV, AUV and other offshore/onshore structure, infrastructure and equipment in seawater, wastewater, or freshwater, or any part of these.

Preferably, the sensing device is located in, attached to, or coupled to a sea vessel's (for example a ship or boat) water inlet, sea chest, ballast, or ballast water tank and inlets.

According to further aspect of the invention there is proved a method of detecting biofouling, the method comprising: operating a sensing device as described herein. Preferably the device is operated in a marine environment.

According to further aspect of the invention there is proved a method of detecting biofouling. The method comprises a) providing a sensing device as described herein; b) transmitting a microwave signal to the electromagnetic wave sensor; c) receiving the reflected microwave signal from the sensing component; d) calculating or detecting any change in the reflected microwave signal from the sensing component; and e) indicating if there has been any change in the reflected microwave signal from the sensor, wherein a change in the reflected microwave signal from the sensor may be an indication of biofouling on the substrate.

Preferably, the method further comprises, prior to b., generating a microwave signal, preferably wherein the signal is in a frequency range of about 1.5 to 7 GHz.

Preferably, the method comprises further comprising using a vector network analyser to generate the microwave signal and to receive the reflected signal from the electromagnetic wave sensor representing a measurement performed by the sensor.

Preferably, the method comprises visually displaying the indication of biofouling. Preferably, detecting biofouling comprises detecting a level of biofouling or percentage of biofouling of the sensed area. Preferably, the method takes places in situ in a marine environment or an environment where biofouling may occur, or the method takes places before a substrate is to be placed in a marine environment or an environment where biofouling may occur, or the method takes place after a substrate has been placed in a marine environment or an environment where biofouling may occur.

According to further aspect of the invention there is proved a method of manufacturing a sensing device for detecting biofouling, the method comprising: enclosing an electromagnetic wave sensor in silicone using a mould. Preferably the method further comprises pouring silicone into a first part of the mould, arranging a second part of the mould to enclose the silicone, and pushing the electromagnetic wave sensor into the silicone through a remaining gap in the mould. Preferably, the method further comprises placing a coupon etched with a microtopography onto the poured silicone prior to arranging the second part of the mould.

It will be appreciated that preferred features ascribed to one aspect of the invention applies mutatis mutandis to each and every aspect of the invention.

### BRIEF DESCRIPTION OF THE DRAWINGS

Embodiments of the present disclosure will now be described with reference to the accompanying drawings, by way of example only, in which:

FIG. 1a to 1D show four embodiments of the invention, four different sensors with differing electrode numbers and geometries;

FIG. 2 shows a schematic example of an embodiment of the invention;

FIG. 3 shows IDE geometries;

FIG. 4A shows 1 Line Au PTFE Sensor Wet (a). 1 line Au PTFE with the Reflection Coefficient S11 dB for the Treatment (n=5) and Control (n=1) panels from 10 MHz to 15 GHz. Figures I., II. and III. show the output at 1 to 5 GHz, 5 to 10 GHz and 10 to 15 GHz, respectively. FIG. 4B shows 1 Line Au PTFE Sensor Dry (b). 1 line Au PTFE with the Reflection Coefficient S11 dB for the Treatment (n=5) and Control (n=1) panels from 10 MHz to 15 GHz. Figures I., II. and III. show the output at 1 to 5 GHz, 5 to 10 GHz and 10 to 15 GHz, respectively;

FIG. 5A shows 3 pr Au PTFE Sensor Wet (a). 3 pr Au PTFE with the Reflection Coefficient S11 dB for the Treatment (n=5) and Control (n=1) panels from 10 MHz to 15 GHz. Figures I., II. and III. show the output at 1 to 5 GHz, 5 to 10 GHz and 10 to 15 GHz, respectively; FIG. 5B shows 3 pr Au PTFE Sensor Dry (b). 3 pr Au PTFE with the Reflection Coefficient S11 dB for the Treatment (n=5) and Control (n=1) panels from 10 MHz to 15 GHz. Figures I., II. and III. show the output at 1 to 5 GHz, 5 to 10 GHz and 10 to 15 GHz, respectively.

FIG. 6A shows 9 pr Au PTFE Sensor Wet (a). 9 pr Au PTFE with the Reflection Coefficient S11 dB for the Treatment (n=5) and Control (n=1) panels from 10 MHz to 15 GHz. Figures I., II. and III. show the output at 1 to 5 GHz, 5 to 10 GHz and 10 to 15 GHz, respectively; FIG. 6B shows 9 pr Au PTFE Sensor Dry (b). 9 pr Au PTFE with the Reflection Coefficient S11 dB for the Treatment (n=5) and Control (n=1) panels from 10 MHz to 15 GHz. Figures I., II. and III. show the output at 1 to 5 GHz, 5 to 10 GHz and 10 to 15 GHz, respectively;

FIG. 7A shows 2×3 pr Au PTFE Sensor Wet (a). 2×3 pr Au PTFE with the Reflection Coefficient S11 dB for the Treatment (n=5) and Control (n=1) panels from 10 MHz to 15 GHz. Figures I., II. and III. show the output at 1 to 5 GHz, 5 to 10 GHz and 10 to 15 GHz, respectively; FIG. 7B shows 2×3 pr Au PTFE Sensor Dry (b). 2×3 pr Au PTFE with the Reflection Coefficient S11 dB for the Treatment (n=5) and Control (n=1) panels from 10 MHz to 15 GHz. Figures I., II. and III. show the output at 1 to 5 GHz, 5 to 10 GHz and 10 to 15 GHz, respectively;

FIG. 8 shows the frequencies identified for various experimental conditions;

FIG. 9 shows the air spectrum of the VNA and the Additional Coaxial Cable;

FIG. 10 shows thew reflection coefficients of the 8 pr Au PVDF and 9 pr Au PTFE Sensor with Air;

FIG. 11 shows the Reflection Coefficient for the V40 H150 Antifouling Microtopography Treatment (with byssi) (n=1) and Control (without byssi) (n=1), and the Average Reflection Coefficient for the Smooth Sensory Surface Control (without byssi) (n=1); and

FIG. 12 shows The Average Reflection Coefficient for the V40 H150 Microtopography Treatment (byssi; n=1) and Control (no byssi; n=1) at 3.43 GHz with the standard error of the average of the repeat measurements.

Like reference signs refer to like features throughout the drawings and the disclosure. Positional descriptions of sensors, e.g. “top”, “bottom”, “side”, are only relative terms used to describe specific embodiments and not meant to be limiting on the invention.

### DETAIL DESCRIPTION

Embodiments will now be described in detail with reference to the accompanying drawings. In the following detailed description numerous specific details are set forth by way of examples in order to provide a thorough understanding of the relevant teachings. However, it will be apparent to one of ordinary skill in the art that the present teachings may be practiced without these specific details.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

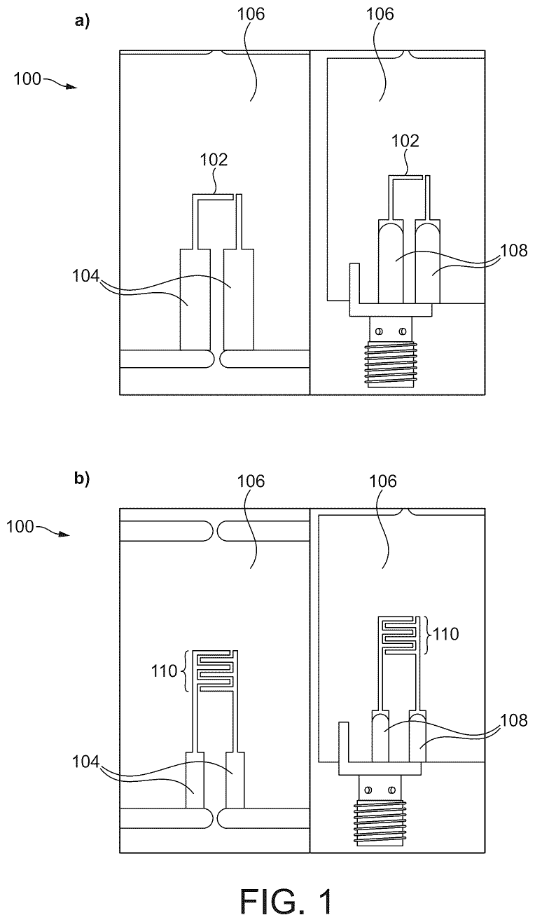

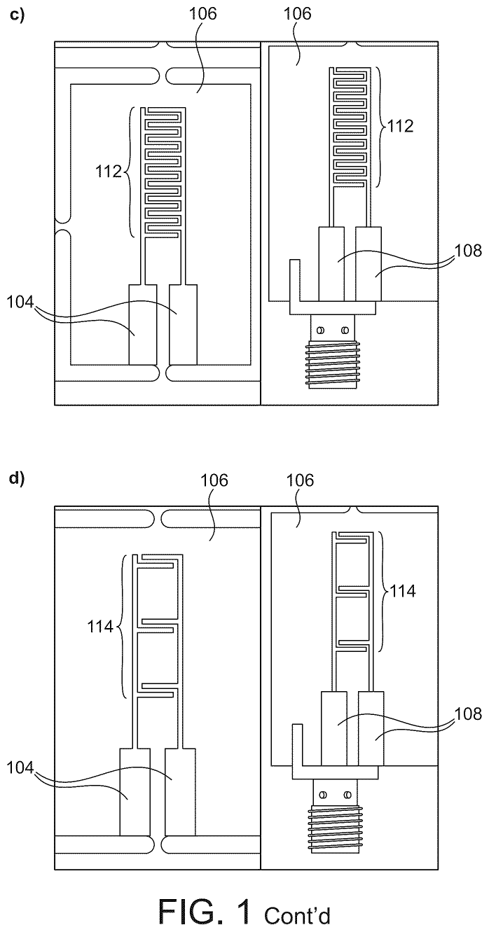

FIGS. 1a to 1d show four embodiments of the invention, four different sensors with differing electrode numbers and geometries. Each sensor in each of the figures is presented here before (left) and after soldering of the RF coaxial cable (Subminiature version A type, SMA) connector (right), SMA used for high frequency connections in the microwave region. Any such suitable connector in the art could be used. These are four planar electromagnetic wave sensors shown. When multiple electrodes are interdigitated, these are called interdigitated electrodes (IDEs). FIG. 1A shows a single electrode sensor, a one line electrode sensor. FIG. 1B shows a three pair of electrode sensor (3 pr), where all of the electrodes are interdigitated. FIG. 1C shows a nine pair of electrodes sensor (9 pr), where all of the electrodes are interdigitated. FIG. 1D shows a 2×3 pr electrode sensor (2×3 pr), which differs from the electrodes of FIGS. 1A to 1C in that it contains 3 pairs of 2 electrodes covering a distant equal to that of the 9 pr sensor, but with a reduced number of IDEs.

In FIG. 1A the one line electrode is labelled 102. In FIG. 1B the 3 pair IDE is labelled 110. In FIG. 1C the 9 pair IDE is labelled 112. In FIG. 1C the 2×3 pair IDE is labelled 114.

Each sensor comprises a sensing substrate (106) which the electrodes are on or embedded, back plate (104). Here the substrate is Polytetrafluoroethylene (PTFE) but as outlined later, the substrate may vary. This substrate is not the substrate on which the biofouling deposition will occur, but a ‘sensing’ ‘second’ or ‘further’ substrate to where deposition to be sensed will be occurring. In use, the sensor may be embedded or on the substrate on which the biofouling will occur, or it may be embedded or on another substrate which is proximal to the substrate on which the biofouling will occur. This is outlined further below. Here the back plate 104 and the electrodes (102, 110, 112, 114) are gold (Au), but these also may vary. The back plate is the microwave launching pads that an SMA is soldered to. These are metallic or any suitable conductive material.

As shown in the right hand of each of FIGS. 1A to 1D, each sensor has a radio frequency (RF) coaxial, SubMiniture version A (SMA), straight jack (50 ohm) connector soldered on for attachment to the VNA.

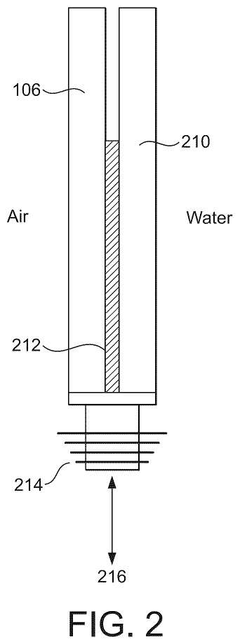

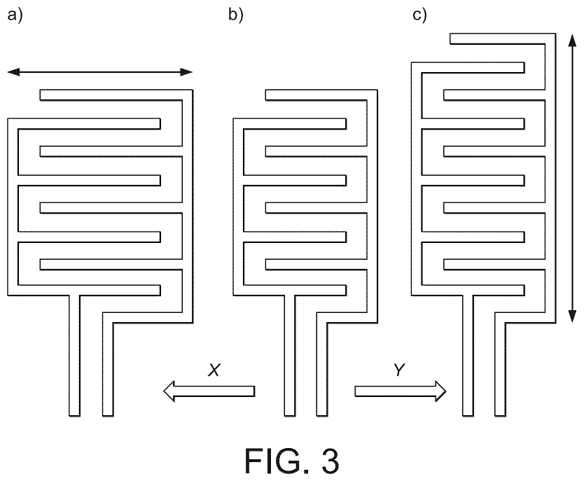

FIG. 2 shows a schematic example of an embodiment of the invention. Here sensing substrate (106) comprises the electromagnetic wave planar sensor (212), which is proximal to deposition substrate 210. Substrate 210 is in water, so biofouling may occur on that substrate. Sensor 212 is capable of returning a signal which would indicate if there is any biofouling. SMA 214 is connected to the sensor. 216 indicates the signal that will be transmitted to and reflected from the sensing components (the sensor 212 and substrate 210). Air and water indicate the separate exposures of the surfaces. Substrate 106 may not be present and the sensor 212 just located on the opposite side of substrate 210 in some embodiments.

Electromagnetic wave (EMW) planar sensors with an interdigitated electrode (IDE) array are described herein. These type of EMW sensors have shown application in a variety of fields from the detection of heavy metals such as lead, to biomedical applications such as in the detection of lactate. Microwave based detection may help to analyse multiple parameters and therefore give a unique signal spectrum dependant on the material under test (MUT). With the vast diversity of the biofouling community, a contactless sensor based on the interaction of the propagation of the EMW and the MUT is reported here in terms of scattering parameters (S-parameters) as the Reflection Coefficient of S11 (the scattering parameter for a one-port network) is dependent on the relative permittivity of the MUT. Permittivity is measured based on the ability for the MUT to polarise due to the applied electromagnetic field (relative permittivity) (equation 2.1)

$$ε r = {ε}^{′} - j {ε}^{″} \qquad Equation 2.1$$

Whereby the permittivity (εr) is defined based on the materials ability to transmit an electric field, accounting for the energy stored (ε′) and any losses (ε″) (j is a complex or imaginary number) (Mason, A., Goh, J. H., Korostynska, O., Al-Shamma'a, A. I., Field, M. and Browning, P. (2013) Real-Time Monitoring of Bodily Fluids Using a Novel Electromagnetic Wave Sensor. Public Health Frontier, 2, pp. 201-206; Mason, A., Korostynska, O., Ortoneda-Pedrola, M., Shaw, A. and Al-Shamma'A, A. (2013) A resonant co-planar sensor at microwave frequencies for biomedical applications. Sensors and Actuators, A: Physical. Elsevier B.V., 202, pp. 170-175; and Moejes, K., Sherif, R., Dürr, S., Conlan, S., Mason, A. and Korostynska, O. (2018) RealTime Monitoring of Tetraselmis suecica in A Saline Environment as Means of Early Water Pollution Detection. Toxics, 6 (4), p. 57, each of which is incorporated herein by reference). This complex value is varied with a changing frequency as well as with changes in the material (e.g. concentration) impacting on its permittivity. A vector network analyser (VNA) is used to measure these changes allowing for the detection or characterisation of a MUT. By measuring a full spectrum of frequencies from 10 MHz to 15 GHz with 60,000 measurements between, the likelihood of finding an appropriate frequency where a change is measurable is increased.

The signal strength of an IDE is dependent on its geometry: area, width and gaps between electrodes. The efficiency of an IDE (IDE_{eff}) is defined as the ratio of the sensing area (A) to the total area of the sensor (A′) (equation 2.2).

$${IDE}_{e f f} = \frac{A}{{A}^{′}} \qquad Equation 2.2$$

Based on this equation, efficiency for a simple IDE senor is deduced based on the geometry of the finger electrodes based on the width (X), height (Y), electrode width (E) and the gap width (G) (equation 2.3) (Grover, W. H. (1999) Interdigitated Array Electrode Sensors: Their Design, Efficiency, and Applications. Honors thesis, University of Tennessee, 3, pp. 1-62, incorporated by reference herein).

The efficiency of a generic sensor is denoted in the equation that may be optimised by rounding the corners of the electrodes and therefore ensuring the width remains constant across the entire sensor. Therefore, the G-term (2) in equation 2.3 is then defined as equal to (2−π2) and the increase in efficiency is determined with the reduced gap width from 2 to 0.429 (arbitrary units). However, the optimisation of the sensor efficiency is additionally improved by changing the dimensions in either the X or Y element by increasing the length of the electrode fingers or by adding additional fingers, respectively (as outlined in FIG. 2).

$${IDE}_{e f f} = \frac{\frac{G Y}{G + E} ( X - \underline{2} G - E ) + {G}^{2} + G E}{X Y} \qquad Equation 2.3$$

FIG. 3 shows IDE Geometry Modification where there can be an increase in the length of the electrode fingers (direction X) (from b to a) and an increase in direction Y with additional electrodes (from b to c) (Grover, W. H. (1999) Interdigitated Array Electrode Sensors: Their Design, Efficiency, and Applications. Honors thesis, University of Tennessee, 3, pp. 1-62, incorporated by reference herein).

Increase in the width and number of the electrode fingers may result in a proportional increase in the signal. This is further corroborated with simulations that showed changes in geometry resulted in changes in the penetration height of the electromagnetic field, which may therefore be designed to detect in the near-field. The IDE array type sensors of the embodiments herein are shown to have many benefits including the high sensitivity to nearby changes that rapidly decays with distance.

Gold electrodes are demonstrated herein. These have advantageously inert nature and good electrical conductivity. These are suitable for use with sea water. However, the electrodes may not be exposed to any sea water, so it is not necessary to construct the electrodes from gold. Any such suitable material for the electrodes known to a person of skill in the art may be used, capable of receiving the microwave signals for the detection described in the present disclosure.

Such a sensor may have an electromagnetic wave sensor developed using conductive paints or inks, such as those based on carbon/graphene that may be used in biosensors. Suitable electrode materials include metals, conductive inks or paints or carbon based materials. The use of conductive paints may allow for the IDE to be directly screen printed to the surface, particularly in niche areas. Metals may be gold, silver, nickel, platinum and aluminium. Carbon based materials may be graphite or graphene.

Application of IDE planar sensors is dependent on the geometry of the electrodes whereby the efficiency is defined in equation 2.3 (above) and an increase in the width and/or number of electrodes may increase the signal. IDE sensors may exhibit high sensitivity in the near-field, however, an increased penetration height of the electromagnetic field may cause the non-specific acoustic sensor to detect beyond the surface, which may result in an unreliable measurement due to the dynamic nature of the biofouling environment. It is therefore an important feature of the sensor to maintain near-field detection, which may only occur with maintaining a small IDE gap. Using smaller electrodes the electric field is confined closer to the surface with 80% of the electric field and current flow between two electrodes in a layer less than L/2 (L=sum of electrode width).

The electromagnetic wave sensor described herein may comprise interdigitated electrodes. Interdigitated electrodes are individually connected/addressable electrodes which are configured to be interdigitated with one another. This allows a reduction in the distance between electrodes, allowing increased power density, quicker ion diffusion and increased sensitivity in sensing applications. Two or more electrodes may be interdigitated in the sensor devices described herein. Parts, e.g. fingers, of each electrode of the sensor devices described herein may be interdigitated with each other in the sensor devices described herein.

As demonstrated herein, electrodes may have pairs of fingers. Each electrode may have two or more fingers. Electrodes described herein are described as having “fingers”, a standard term in the art to mean an elongate part of an electrode.

An IDE may have pairs of fingers, where a finger of each of at least two of the electrodes are interdigitated as a pair. An IDE may have two or more pairs of fingers, and there is no upper limit on the number of pairs of fingers. For example, there may be up to 10, 20, 30, 40 or 50 pairs of fingers.

By increasing the number of electrodes on the sensor to for example 3 to 9 or more pairs a resultant increase in the sensing area and sensing capacity may be demonstrated with a relatively stable frequency at which detection occurs, a phenomenon widely demonstrated.

As demonstrated herein, electrodes of certain pair number are not impacted by orientation of the electrodes relative to any biofouling being studied.

The electromagnetic wave sensor must be somewhat proximal to or coupled to the substate on which the biofouling will be detected. For example, they may be located on the opposite surface of the surface to the surface of the substrate on which the biofouling will occur. Preferably, the electromagnetic wave sensor (particularly the electrodes) are not exposed to the water from which the biofouling may occur, otherwise any deposition on the electrodes may mean that the field is not generated and the sensing device would i work. Thus, the electromagnetic wave sensor should be protected from the environment from which the biofouling may occur, for example the electromagnetic wave sensor is enclosed or sealed to prevent any exposure to water. The electromagnetic wave sensor may only be exposed to air. The electromagnetic wave sensor may be encased so as to not be exposed to any water. In the device the electromagnetic wave sensor is not exposed to any water or biofouling on the electromagnetic wave sensor may occur.

The electromagnetic wave sensor may be located proximal to or coupled to the opposite surface of the surface to the surface of the substrate on which the biofouling will occur, but not actually located on the opposite surface of the surface to the surface of the substrate on which the biofouling will occur. For example they may be located on a further substrate or plate which is located so that the electromagnetic wave sensor is proximal to, next to or pressed against the opposite surface of the surface to the surface of the substrate on which the biofouling will occur. The substrate on which biofouling will occur and be measured may be termed the ‘deposition substrate’ or the ‘biofouling substrate’. The substrate which the sensor is embedded or on may be termed the ‘sensing substrate’ or the ‘further substrate’ or the ‘second substrate’.

Reference herein to “coupled to” refers to a device which is for use with something, this may be attached, adhered to using any method known in the art or just simply located on or with or proximal so as to be able to detect biofouling using the field generated as described herein.

Sensors comprise a substrate where on which the detection of biofouling takes place. The sensor components (e.g. electrodes) which are used to detect the biofouling are coupled to or located proximal to this substrate so as to be able to detect the biofouling has occurred. This substrate may in turn be a part of, or attached to whatever the user wishes to detect biofouling on (i.e. the biofouling will occur on the substrate, but be indicative of overall biofouling in the area which is of interest, i.e. part of a ship, underwater object). The device may be a self contained device attached to or placed on something on which biofouling may occur. Or, the device may be incorporated into the something on which biofouling may occur, so that the substrate is exposed to the water from which the biofouling may occur. For example, the substrate may be a part of a pipe, a part of a wall of a sensor or ship hull, ballast, water inlets, ballast water tanks or inlets, or sea chest, so that the sensors are not exposed to the water but the substrate is, whilst being a part of whatever it is incorporated into. The substrate may be a panel.

The substrate may be coupled to or part of any surface where biofouling may occur, such as those associated with sea vessel, boat, submarine or ship parts, for example hulls, underwater cables, oil rig platforms or parts of oil rigs, buoys, and fishing nets or fishing apparatus, underwater structures such as energy generators, pipelines e.g. oil or telecom pipelines, marine instruments, an underwater recording apparatus, aquaculture infrastructure and equipment, monitoring stations and equipment, cables and their link stations, ROV, AUV and other offshore/onshore structures, infrastructures and equipment in seawater or freshwater, or anything which is exposed to water which could cause biofouling of surfaces exposed to it, for example sea, coastal, water processing waste, harbour, ocean waters, freshwater, wastewater/sewage, water coming from water treatment works or water (e.g. grey and black water) in domestic settings such as in domestic appliances. These may be any surface which may eventually become biofouled due to contact with water comprising species capable of biofouling, such as barnacles, mussels, biofilm, associated debris, macromolecules, and algal species. This may include household wastewater, for example blackwater (sewage from toilets or bathrooms) or greywater (water from kitchens dishwashers etc). This may include wastewater/sewage, water coming from water treatment works. The sensor device may be incorporated into or part of a marine structure, substrate or surface, such as those listed here.

In order for microwave signals for the present invention to be able to detect the biofouling, the substrate is preferably non-metallic. A metallic surface may interfere with the microwave signals and a metallic surface in contact with or just in front of the antenna structure may short the microwave signal and therefore block it. Herein the sensors are demonstrated as being suitable for use with multiple substrates—particularly Nylon, Silicone, Polyvinyl Chloride (PVC, Vinyl) and polytetrafluoroethylene (PTFE; Teflon™). The invention may utilise plastic, polymers and composite substrates. Sensors described herein will work with other materials, such as those used in water-based environments, for example those on a ship, underwater structure or submarine, such as polymers and composites.

The biofouling substrate may be any thickness through which the microwave frequencies of the sensor are capable of detecting biofouling on the surface. For example, the substrate may be at least 0.1 mm thick, preferably at least 0.2 mm thick, preferably at least 0.3 mm thick, preferably at least 0.4 mm thick, preferably at least 0.5 mm thick, preferably at least 0.6 mm thick, preferably at least 0.7 mm thick, preferably at least 0.8 mm thick, preferably at least 0.9 mm thick, preferably at least 1 mm thick. For example, the substrate may be no more than 5 mm thick, preferably no more than 4.5 mm thick, preferably no more than 4 mm thick, preferably no more than 3.5 mm thick, preferably no more than 3 mm thick, preferably no more than 2.5 mm thick, preferably no more than 2 mm thick. For example, the substrate may be between 0.1 mm and 5 mm thick, or a range of any of these thicknesses described here.

The sensing substrate which the sensor may be on or embedded in (if different to the biofouling substrate) may be made from any material suitable to carry the sensors described herein. This might be made from any non-metallic material, to not interfere with the microwaves. For example, this might be Polytetrafluoroethylene (PTFE) or a printed circuit board (PCB) material such as FR4.

The devices may comprise means e.g. circuitry to generate a signal, e.g. a microwave signal to transmit to the electromagnetic wave sensor. This may be a means to generate and transmit a signal. This may comprise a microwave voltage-controlled oscillator (VCO) or a Vector Network Analyser (VNA).

The generation of microwave signal may consume a low level of power, in some examples using less than 10 mW to generate the desired microwave signal. The generated microwave signals are non-ionizing and are therefore safe for the operator or user of the device and other persons in the vicinity of the device when in operation. The microwave generation and transmission means may also comprise means to transmit the signal to the sensor an electromagnetic wave sensor, which acts as an antenna for transmitting the generated microwave signal towards the substrate on which the biofouling is being measured.

The study demonstrated that the 9 pr Au PTFE planar EMW contactless sensor detected the presence of M. edulis byssal plaques on Nylon 6 at 5.84 GHz and 3.41 GHz, Silicone at 6.55 GHz and 3.33 GHz, PVC at 127 4.64 GHz. Thus, the presently described sensors will act to detect biofouling in a microwave frequency range, preferably a range of about 1.5 to 7 GHz, preferably a range of about 2 to 6.5 GHz, preferably a range of about 3 to 6 GHz. Preferably, the sensors will act to detect biofouling in a microwave frequency equal to or less than 7 GHz, preferably equal to or less than 6.55 GHz. Preferably, the sensors will act to detect biofouling in a microwave frequency equal to or greater than 1.5 GHz, preferably equal to or greater than 2 GHz, preferably equal to or greater than 2.5 GHz. Such frequencies have been demonstrated as capable of sensing biofouling.

The methods and sensors described herein may be supplied with a frequency range in operation, not just a specific frequency.

The devices described herein may further comprise a detector to detect a reflected or backscattered, signal frequency from the sensing component (the electromagnetic wave sensor/antenna and the substrate where they may or may not be biofouling). The detector measures the reflected microwave signal from the sensing element. The resonance structure of the electromagnetic wave sensor changes due to the microwave interaction with the substrate and plaques, and the detector will measure the reflected or backscattered, signal frequency. In some embodiments, it is possible to detect the phase and magnitude component of the reflected/backscattered/returned microwave signal. This aids the pre-processing of the data and interpretability. For example, a VNA can be used as it produces the phase and magnitude component of the reflected/returned/backscattered microwave signal.

The devices described herein may further comprise a controller. A controller may comprise controller circuitry. The controller circuitry may be in the form of a processor or microcontroller. The sensing device may further comprise a controller to detect (if not the detector) and compute the reflected or backscattered microwave signal frequency from the substrate and calculate a level of biofouling on the substrate. This may come from the detector first. A level of biofouling might be compared to a control/reference level or a predetermined threshold level by the controller. The predetermined threshold value may be stored in the storage means and used by the controller to determine whether a biofouling level is equal to or greater than the predetermined threshold level. The control/reference level or a predetermined threshold level might be an earlier level of biofouling on the same substrate. This might be able to lead to a calculation of a change in biofouling over time on the same substrate. The level might give an indication of ‘biofouling’ or ‘no biofouling’. This might be a % of biofouling.

A controller circuitry may be connected to storage means. The storage means may be in the form of a memory or memory circuitry, such as an EEPROM, for storage of processing instructions and data. The detected reflected or backscattered signal frequency from the substrate received can be stored on the storage means. Multiple storage means can be provided to segregate the processing instructions from stored data. The storage means for data may be provided in the form of removable memory circuitry, such as a Secure Digital (SD) card or a flash drive, enabling the data to be taken from the device to be analysed on another device, such as a computing device. The storage might store earlier levels of biofouling detected on the same substrate, including a detection of zero or no biofouling. This might mean the controller is able to calculate a change in biofouling over time.

The devices described herein may further comprise means display the reflected microwave signal frequency from the electromagnetic wave sensor. These might be a visual display These may be part of the controller or a separate part. This might comprise a biofouling level indicator. This might comprise a display. The display may comprise one or more light emitting device to indicate the biofouling. The light emitting devices may be, for example, light emitting diodes (LEDs). The display may comprise a plurality of means to indicate different levels of detected biofouling.

A numeric display may indicate a level of biofouling detected. For example, a level of biofouling may be calculated as a percentage % of area sensed. This may be calculate as a percentage and then displayed in another more visual form, or displayed as a percentage. There may be a threshold percentage of area sensed which indicates biofouling or the start of biofouling, for example an indication of presence of deposition on at least 1% of the area sense may lead to a positive indication of biofouling. Or, an indication of presence of deposition on 2%, 3%, 4%, 5%, 8%, 10%, 15%, 20%, 25%, 30% of the area sense may lead to a positive indication of biofouling.

Alternatively, or in addition to the visual representation of the detected biofouling dosage level, the insecticide dosage level indicator may comprise an audible indicator to audibly indicate a detected biofouling level. The audible indicator 50 may comprise a speaker. An audible tone may be emitted by the audible indicator to indicate that biofouling level is above a predetermined threshold value. The predetermined threshold value may be stored in the storage means and used by the controller to determine whether a biofouling level is equal to or greater than the predetermined threshold level.

A controller may comprise a communication means to communicate with external devices, wherein the detected biofouling level and/or the reflected microwave signal can be transmitted to the external device for further processing or storage. Furthermore, stored data may be transmitted to the external device. The communication means may be in the form of communication circuitry. The communication means may be a Bluetooth device, WiFi device, Zigbee device, or other wireless communication means. Alternatively, the communication means may provide communication via wired connection, such as an ethernet connection, a serial connection, or a Universal Serial Bus (USB) connection. The communication means may also be used to receive firmware updates for the device.

The power section of the sensor device may provide suitable power for the operation of the of the device, and may comprise, or be capable of receiving, replaceable or rechargeable batteries. The power section may have voltage conversion circuitry to provide the correct voltage for operation of the electronic components of the device. It will be understood that in some embodiments the batteries may be selected to provide the correct voltage without voltage conversion. The use of batteries enables the device to be portable and to be used in remote locations where other sources of power may be unavailable.

As used herein, “sense”, “detect”, “monitor” may be used interchangeable and refer to the use of the herein described systems, apparatus or sensors to sense, detect and/or monitor biofouling.

Any sensor device as described herein may be part of a sensor device array, or a sensor device array network, which comprises one or more sensor devices and other components. The array may comprise two or more sensor devices. Multiple sensor devices may be located in multiple locations across something which it would be desirable to detect biofouling on.

A sensor device in an array may be connected to other sensor devices in this array, or to other components in the array which allow linkage of multiple sensor arrays to each other or other components of the array. Any sensor device within such an array may have additional components which allow linkage of multiple sensor arrays to each other or other components of the array.

Different biofouling detecting sensor devices may be linked in an array, for example different sensor device types or sensors with different geometries. A sensor array network may overcome limitations or a single device, and can use different sensor geometries including circular or hexagonal arrays.

The sensors and methods described herein may be used in a marine environment. A marine environment is any environment with the capability of leading to biofouling on a surface, so an environment where organisms capable of biofouling are present. A marine environment is defined as any environment where biofouling may occur. A marine environment is one which somehow has, will or may involve ocean or coastal waters,. The sensors and methods described herein may be used in a non-marine environment where biofouling may occur, for example in a river or a lake. freshwater, wastewater/sewage, water coming from water treatment works or water (e.g. grey and black water) in domestic settings such as in domestic appliances. The sensors and methods described herein may be used in a household environment, for example with household wastewater. They may be used to test something which comes into contact with the blackwater (sewage from toilets or bathrooms) or greywater (water from kitchens dishwashers etc). The sensors and methods described herein may be used in an environment where wastewater/sewage, or water coming from water treatment works passes through, for example in treatment work pipes. They may also be used with something which has previous been in a marine or freshwater environment, for example something that has been in the sea or a lake. For example a ship which has previously been in the ocean and is now being exampled. Or a marine or freshwater environment may refer to something which may be in such an environment in the future, for example a sensor device which is to be placed in a river or the ocean in the future. Something may presently be in such an environment at the time of interest. For example, something in a marine environment may be something currently in the ocean, for example a submarine.

Biofouling is the settlement of sessile (immobile organisms) organisms and/or biofilms. Biofouling is defined to begin moments after any object enters a body of water. Biofouling is defined as the adhering or colonisation process of a solid surface (living or dead) by sessile organisms or one or more precursors to the adhering of or colonisation process by sessile organisms. Biofouling is deposition of or a precursor to the deposition of macromolecules, biofilm and/or macrofouling. Biofouling may include one or more of the following steps: (1) the adsorption of a ‘conditioning film’ (dissolved organic molecules), (2) colonisation by prokaryotes, (3) dispersion of some cells, (4) colonisation by unicellular eukaryotes (e.g. diatoms, ciliates and flagellates), and/or (5) colonisation by multicellular eukaryotes. A biofilm is not necessarily needed for the formation of macrofouling and some invertebrate larvae are able to settle permanently on clean surfaces within a short period of time, quicker than the colonisation by some prokaryotic bacteria. So biofouling as described and sensed herein may include biofouling by microfoulers (1-4) and macrofoulers (5). The presently described inventions may sense or detect any one of these stages or types of organism or microorganisms.

Herein M. edulis plaques are used as a model biofouling organism. But this is just a model organism. The sensors herein would work to detect biofouling of any sort of organism. This is a suitable organism to demonstrate the ability to detect biofouling because it uses an attachment mechanism indicate of most biofouling. During testing the actual organism was often cut off, and the biofouling detection demonstrated by the proteins attached to the substrate. These are similar across all biofouling organisms. Thus, this model organism means the device will work to detect biofouling more generally.

The devices described herein may be used in methods of detecting biofouling. Such methods may comprise providing one or more of the sensors described herein. Then signal, preferably a microwave signal, is transmitted to the electromagnetic wave sensor. A signal will then be reflected from the substrate which is coupled to the sensor, and this signal will be received. From this received signal, any change in the signal from the originally transmitted signal can be detected or calculated. This change will give an indication of if there is any biofouling on the substrate, as demonstrated herein. A change in the reflected microwave signal from the sensor may be an indication of biofouling on the substrate. A signal might be first generated, as described herein. This may be by a vector network analyser or a microwave voltage-controlled oscillator as described herein.

As described herein, the generated signal may be in a frequency range of about 1.5 to 7 GHz, or another frequency or range described above.

As described herein, a controller may measure, detect or calculate the change in the signal. This might compute or calculate a change in the signal and thus an indication of biofouling on the substrate. There may be a means to display an indication of biofouling on the substrate, and the method might include displaying the indication of biofouling on the substrate, e.g. the level of biofouling or percentage of biofouling of the sensed area. A level might an indicate of some or no biofouling.

The method may further comprise using a vector network analyser to generate the microwave signal and to receive the reflected signal from the electromagnetic wave planar sensor representing a measurement performed by the sensor.

The method may take places in situ. This may be in a marine environment or an environment where biofouling may occur, or the method may take places before a substrate is to be placed in a marine environment or an environment where biofouling may occur, or the method may take place after a substrate has been placed in a marine environment or an environment where biofouling may occur.

A method of manufacturing a sensing device for detecting biofouling is also described and demonstrated here. The method comprises enclosing an electromagnetic wave planar sensor in silicone using a mould. The method may comprise pouring silicone into a first part of the mould, arranging a second part of the mould to enclose the silicone, and pushing the electromagnetic wave planar sensor into the silicone through a remaining gap in the mould. The method may comprise placing a coupon etched with a microtopography onto the poured silicone prior to arranging the second part of the mould.

### EXAMPLES

### Example 1

### First Set of Experiments

M. edulis Collection and Culture

Specimens of M. edulis were collected from the Liverpool Royal Albert Dock (53°24′02.9″N 2°59′30.6″W) and Liverpool Watersports Centre (53°23′33.9″N 2°59′07.6″W) in Liverpool, UK. Biofouling present on shells was removed using a sponge scourer. A monoculture of M. edulis, between 3 to 6 cm in length, were then kept in Exo Terra standard Faunariums (30×19.3×20.6 cm) in 28 psu artificial seawater (Aquarium Systems Instant Ocean Sea Salt) (measured with a refractometer) in the LJMU NSP cold room at 8° C. with aeration and regularly fed with the planktonic diatom Tetraselmis suecica. T. suecica was obtained from cultures maintained by Dr S. Conlan (BES; Faculty of Science at Liverpool John Moores University). The artificial seawater of the mussel cultures was changed twice a week and the tanks regularly cleaned. Mussels were only exposed to a Treatment once.

### Interdigitated Electrode Sensors

Four planar electromagnetic wave sensors were employed whereby each sensor consisted of a PTFE substrate, a gold (Au) back plate and with varying gold electrode numbers or geometry; 1 line electrode, 3 pair (3 pr) interdigitated electrodes (IDE), 9 pair IDE (9 pr) and 2×3 pair IDE (2×3 pr). Each sensor had a radio frequency (RF) coaxial, SubMiniture version A (SMA), straight jack (50 ohm) connector soldered on for attachment to the VNA (FIG. 1).

### Surface Material Selection

The novel methodology was designed to investigate the ability of the manufactured planar EMW sensors to detect M. edulis byssi plaque on a surface. The localised electric field of the IDE sensors allowed for an estimated penetration height of 1.8 mm. It was therefore concluded that a surface thickness of 1 mm should allow for near-field surface detection only. In total, four materials were selected due to their interaction with both the sensor and the mussel: relative permittivity and hydrophobicity, respectively.

### Analysis

The panels were visually examined and the number of byssal plaques on the surface recorded. The VNA was used to measure the Reflection Coefficient as S11 dB and the mean was calculated per Treatment and per Orientation (where applicable), per panel, at each of the 60,000 measured frequencies between 10 MHz to 15 GHz.

Initial Detection of M. edulis Plaques with Four EMW Sensors with Varying IDE Geometries

Initial Detection of M. edulis Plaques with Four EMW Sensors with Varying IDE Geometries PVC panels (SIMONA via Ensinger Ltd.) of 50×50×1 mm were setup either with a mussel (Treatment) or without a mussel (Control) as the material to function as a surface in these experiments. Individual M. edulis specimens were secured to the Treatment panels with a rubber band whereby the dorsal edge of the shell was perpendicular to the PVC panel. This initial experimental procedure included individual Treatment (n=8) tanks and a Control (n=1) tank of 8.5×15.5×10.5 cm setup with 28 psu artificial seawater and an aerator in an 8° C. cold room for 24 hours.

Following exposure to the Treatment and Control condition, panels were prepared for data collection. From the Treatment panels, the rubber band was carefully cut with scissors and removed, and the mussel byssi threads were cut close to the ventral section of the shell. Sheets of FR4 were laser cut to create 20×20×1 mm wells and double-sided tape was attached to one side of the well. A disposable scalpel was then used to trim the excess double-sided tape. The Control and Treatment PVC panels with byssal plaque present on the surface were selected, the FR4 well secured, the PVC sheet trimmed to size and placed back in 28 psu seawater ready for data collection.

Analysis of the mean Reflection Coefficient S11 dB as a binary (plaque and no plaque or Treatment and Control) in order to identify individual frequencies where the sensors are able to best detect the presence of M. edulis plaque on the PVC panel. The mean Reflection Coefficient at each frequency (60,000 frequency points from 10 MHz to 15 GHz) of the Control panel (5 measurements) and the mean Reflection Coefficient at each frequency for each Treatment panel (5 measurements each) was plotted for both the Wet and Dry Measurements for each of the four sensors. The largest difference in the mean Reflection Coefficient of the Treatment (n=5) and the Control (n=1) across the 60,000 frequency points from 10 MHz to 15 GHz allowed for a single frequency to be deduced where detection is occurring. This was done for each of the four sensors.

The Impact of Orientation on the Detection of M. edulis Plaques with Four EMW Sensors with Varying IDE Geome

Three tanks were set up, Tank I (8.5×15.5×10.5 cm), Tank II (11×17×11.5 cm) and Tank III (11×17×11.5 cm) with 28 psu artificial seawater in an 8° C. cold room. A single PVC panel placed in Tank I and Tank II, with an individual mussel was secured to the Treatment panel with a rubber band for 24 to 96 hours, after which it was replaced with a new mussel secured to the same PVC panel in order to maximise the number of byssi put down. This was done over a 3-week period totalling 14 mussels and 9 mussels for Tank I and Tank II, respectively. 6 PVC panels placed in Tank III with a freely placed individual M. edulis specimen in the tank for 24 to 96 hours, after which it was replaced with a new mussel with the same 6 PVC panels. This was also carried out over a 3-week period totalling 9 mussels for Tank III. An additional Control tank with a single PVC panel in 28 psu artificial seawater was also set up in an 8° C. cold room for a 3-week period. Following exposure to the Treatment or Control condition, the panels were prepared for data collection (as previously described in the Pilot Experiment: Initial Detection of M. edulis Plaques with Four EMW Sensors with Varying IDE Geometries) whereby the rubber band was carefully removed, the mussel byssi threads cut and the FR4 well secured, and the PVC sheet trimmed to size.

The mean Reflection Coefficient of each of the 60,000 frequency points from 10 MHz to 15 GHz, of each Orientation (10 measurements per Orientation) for the Treatment (n=4) and Control (n=1) was deduced. The biggest difference between the mean Reflection Coefficient of the Treatment and the Control for each Orientation was then deduced and the corresponding frequency recorded e.g. difference between mean Reflection Coefficient of the Treatment with three plaques in Orientation A and the Control in Orientation A. This was done with all four sensors. The mean frequency at which the biggest difference per Orientation, per sensor occurred was then graphically presented and compared with the results of the Wet experiment.

Efficacy of Varying Sensing Materials for Detecting M. edulis Plaque on a Surface with the Selected EMW Sensor

Four materials were investigated (PVC, PTFE, Nylon 6 and Silicone) whereby for each material surface, 30×19.3×20.6 cm tanks were setup with a single Treatment panel (with a mussel secured to the panel with a rubber band) (n=40) and a Control panel (no mussel) (n=40) in a single tank with 28 psu artificial seawater in an 8° C. cold room for each of the four materials for 24 hours. With the lower rigidity of the Silicone, a 50×50×1 mm PVC panel was used for support when securing the mussel to the panel and then removed before data collection.

After 24 hours, the panels were prepared with a FR4 well.

The panels were visually examined and the number of plaques on the surface recorded. Data for the number of plaques were tested for the assumptions of normality (Kolmogorov-Smirnov; (Quinn and Keough, 2002)) and homogeneity of variances (Levene's test; (Quinn and Keough, 2002). If assumptions were met a one-way ANOVA (factor 1:4 materials; variable: number of byssal plaques) was used, followed by a Tukey HSD posthoc test to determine differences between materials. Level of significance was 5%. Statistical analysis was conducted using SPSS (Version 26; IBM).

The mean Reflection Coefficient for the Treatment (n=40) and Control (n=40) (3 full sweep measurements of 60,000 frequency points from 10 MHz to 15 GHz per Orientation, per panel) for each of the four materials was plotted using MATLAB (version 9.2; R2018b; Mathworks®). Their respective standard error (SE) values were also plotted as a line, which may indicate frequencies at which the Reflection Coefficient peaks may be unreliable and may therefore be discarded. A previous assumption for detection was that the Control Reflection Coefficient be more negative than the Treatment Reflection Coefficient as affected by the relative permittivity or dielectric constant (A. Mason 2018, personal communication; Moejes et al., 2018). The assumption was that the dielectric constant of the Treatment, with the presence of the M. edulis byssal plaque, allows it to store electrical energy in an electric field resulting in a less negative Reflection Coefficient than the Control, as shown in the equation 1.2. Coupled with the largest difference between the mean Reflection Coefficient for the Treatment and Control, this was used to determine the frequency at which the sensor was able to detect plaque on the surface of each material. Data from each panel (consisting of 12 measurements per panel) measured as Reflection Coefficient were tested for the assumptions of normality (KolmogorovSmirnov; (Quinn and Keough, 2002)) and homogeneity of variances (Levene's test; (Quinn and Keough, 2002)). If assumptions were met a two-way nested ANOVA (factor 1:4 materials, factor 2: Treatment and Control; variable: Reflection Coefficient) was used and to determine differences between materials and a one-way nested ANOVA was used for Treatment differences per material. If assumptions were not met, ANOVA was still used (Underwood, 1996) and the level of significance was always 5%. Statistical analysis was conducted using SPSS (Version 26; IBM).

### Data Collection

A VNA (Rohde & Schwarz ZVA24) was used to determine the S11 scattering parameter (S parameter) by measuring both the amplitude and phase of the signal reflected by the sensor over a frequency range of 10 MHz to 15 GHz with 60,000 data points measured per sweep (for each measurement taken), in a temperature controlled (21° C.) sensor laboratory. A calibration was performed to remove the effect of the coaxial line connecting the VNA to the sensor.

Initial Detection of M. edulis Plaques With Four EMW Sensors With Varying IDE Geometries

With each of the four sensors (1 line, 3 pr, 9 pr and 2×3 pr Au PTFE sensors) 5 full sweep measurements (60,000 frequency points from 10 MHz to 15 GHz) were taken for each Treatment panel (n=5) and the Control panel (n=1) with 400 μl of 28 psu artificial seawater (Wet Measurement). The panel was lifted and placed back between each measurement to account for air entrapment, random error of the placement of the panel, and fluctuations of the instrument and of the environment. After the Wet measurements, excess water was removed from the well and the panels left to air dry on the bench, and 5 full sweep measurements (60,000 frequency points from 10 MHz to 15 GHz) were taken for each Treatment panel (n=5) and the Control panel (n=1) with no seawater (Dry Measurement).

The Impact of Orientation on the Detection of M. edulis Plaques With Four EMW Sensors With Varying IDE Geometries

Each treatment PVC panel (n=4) from Tanks I, II and III, as well as the Control (n=1), had 10 full sweep measurements (60,000 frequency points from 10 MHz to 15 GHz) taken with 400 μl of 28 psu artificial seawater with each of the four sensors and the Orientation noted as Orientation A. The panels were then rotated 90° anti-clockwise to Orientation B where an additional 10 full sweep measurements were taken. Each panel was rotated three times to give four Orientations marked as A, B, C and D, with 10 full sweep measurements per Orientation. Designation of Orientation A was random.

Efficacy of Varying Sensing Materials for Detecting M. edulis Plaque on a Surface With an EMW Senso

Using the selected sensor, for each of the Treatment panels (n=40) and Control panels (n=40) of the four material surfaces, three full sweep measurements (60,000 frequency points from 10 MHz to 15 GHz) were taken per Orientation, resulting in 12 full sweep measurements per panel. The Orientations were no longer marked due to possible interference of the marker properties with the sensor.

### RESULTS

Initial Detection of M. edulis Plaques With Four EMW Sensors With Varying IDE Geometries

5 Treatment panels with 2 plaques, 3 plaques, 6 plaques, 9 plaques and 12 plaques were obtained.

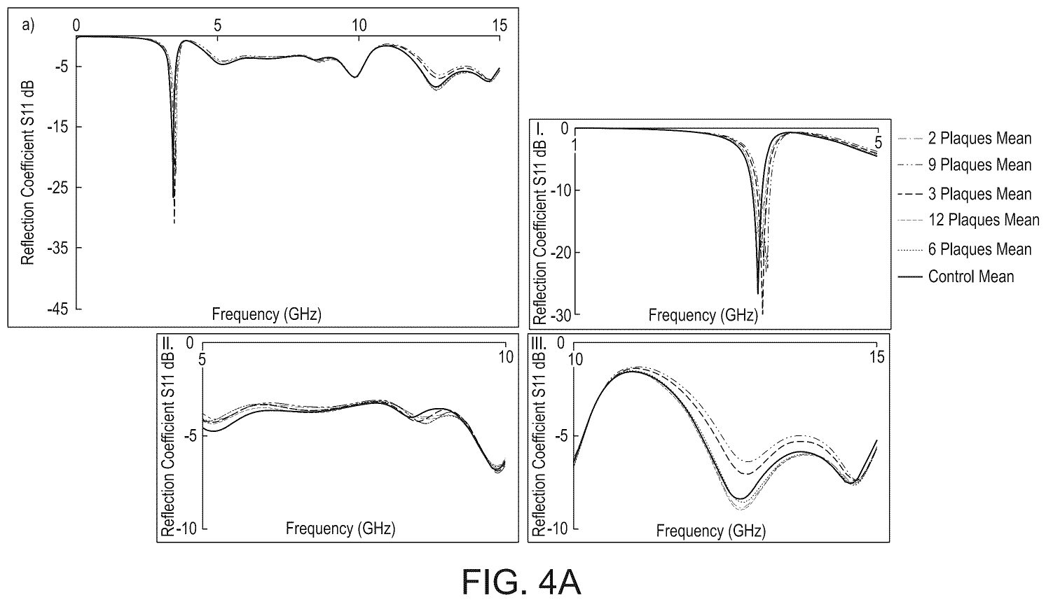

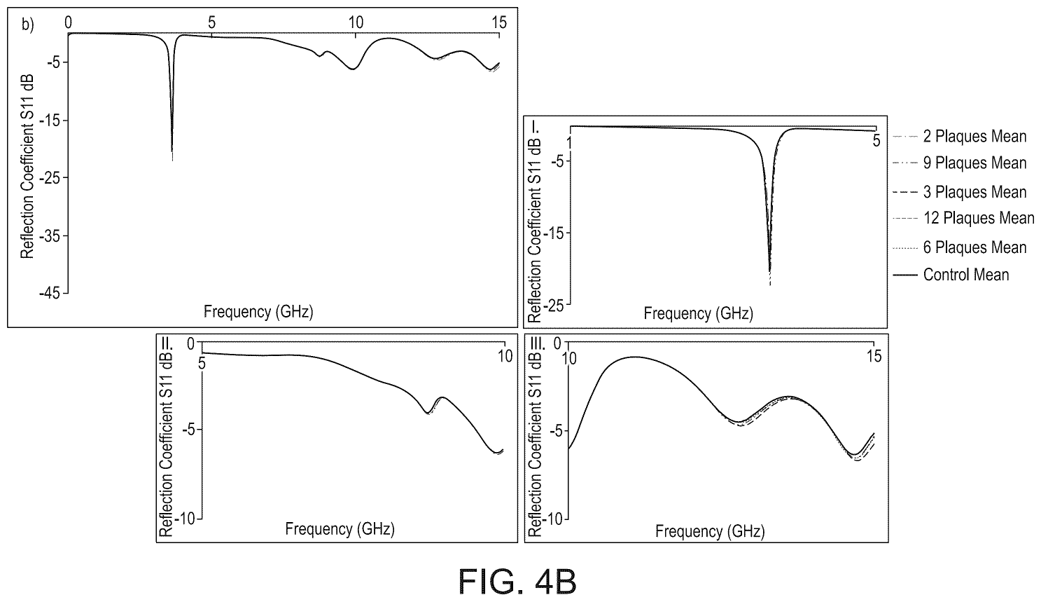

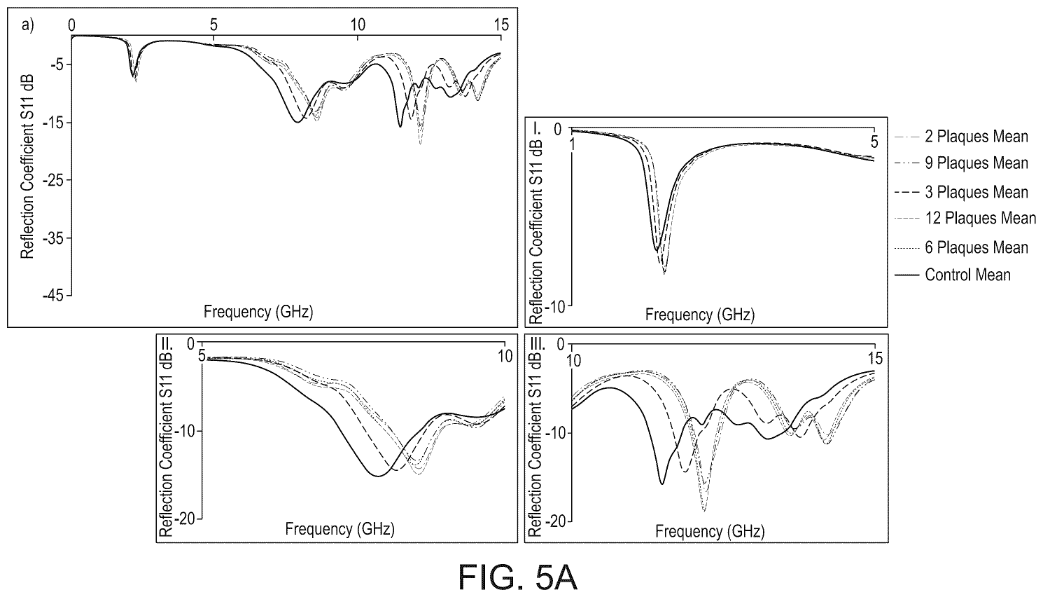

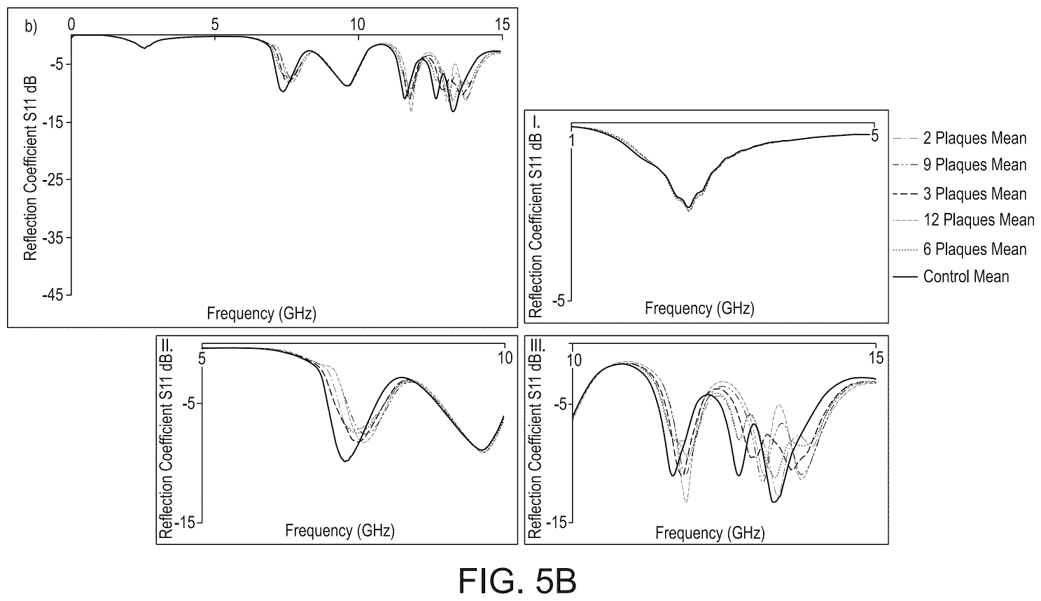

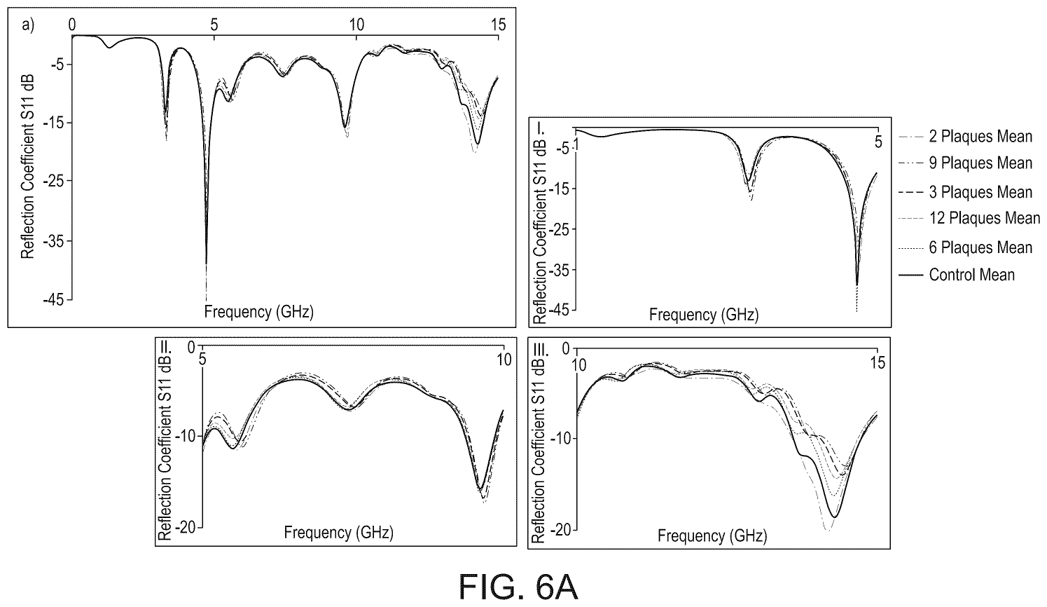

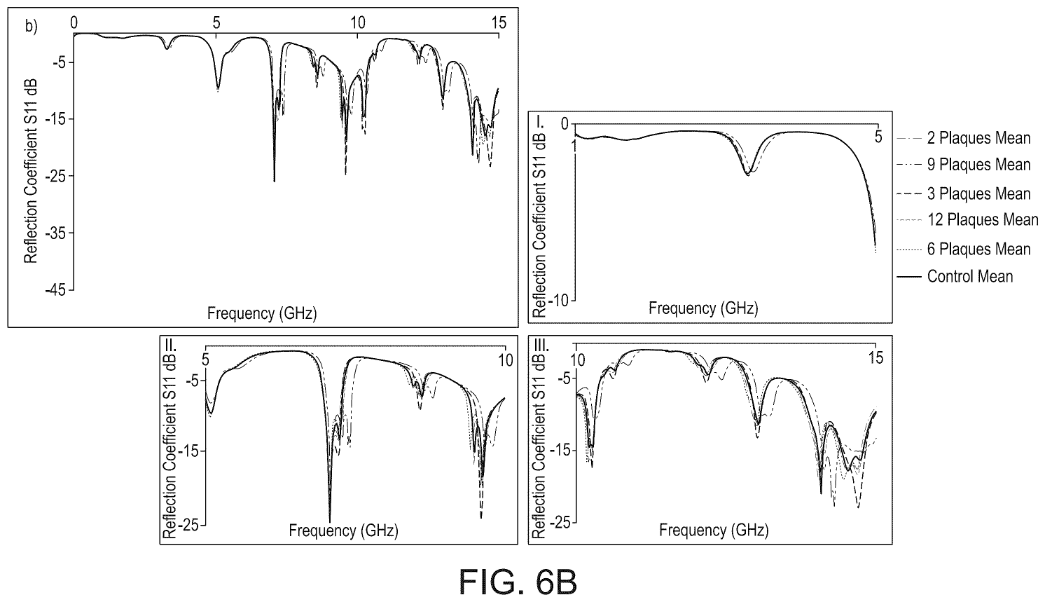

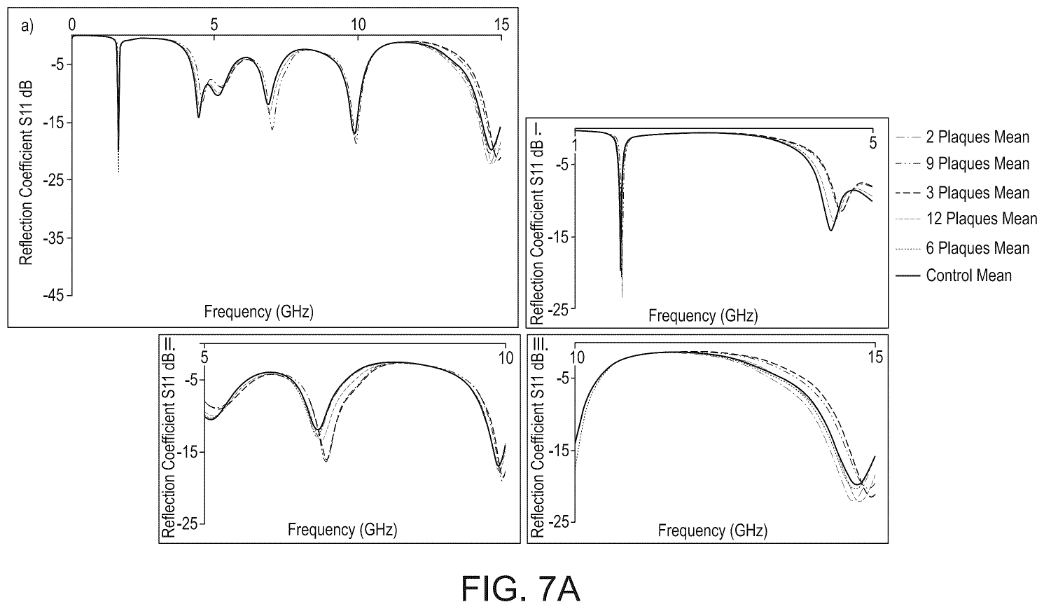

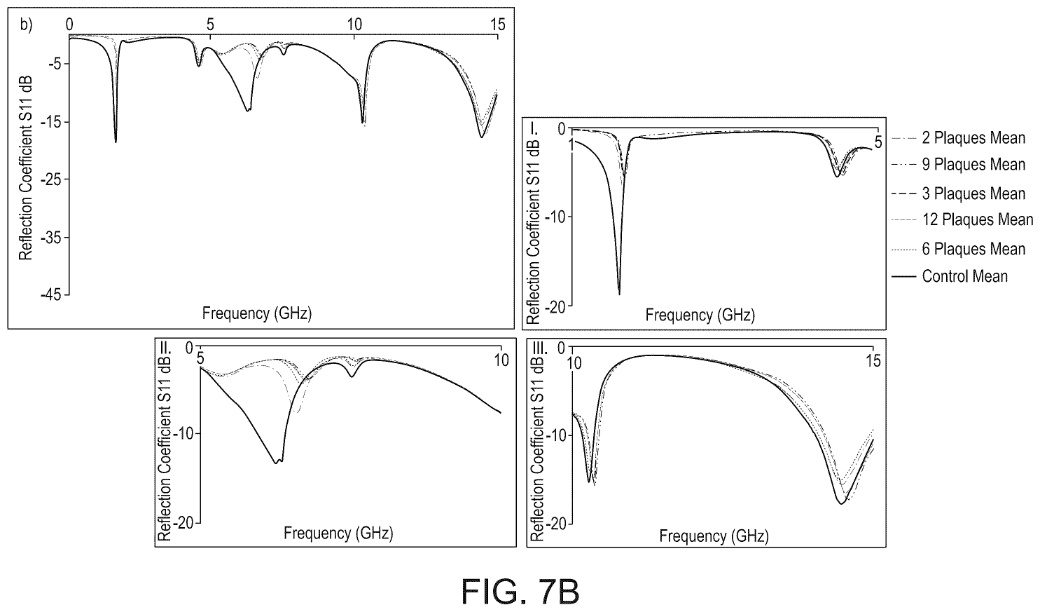

Measurements with artificial seawater (Wet) as well as Dry from 10 MHz to 15 GHz were plotted as the mean Reflection Coefficient of the 5 repeat measurements for the four sensors 1 line Au PTFE (FIGS. 4A and 4B; Wet (a) Dry (b)), 3 pr Au PTFE (FIGS. 5A and 5B; Wet (a) Dry (b)), 9 pr Au PTFE (FIGS. 6A and 6B; Wet (a) Dry (b)) and 2×3 pr Au PTFE (FIGS. 7A and 7B; Wet (a) Dry (b)).

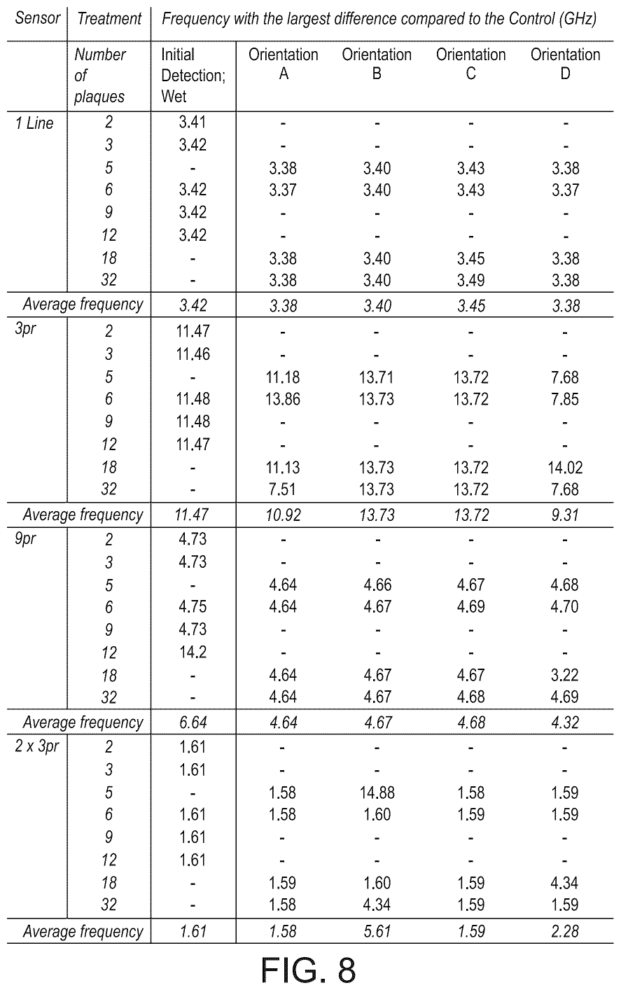

Differences are shown between the Wet and Dry Reflection Coefficient S11 dB outputs with both the Treatments and the Control. In the Wet condition, the 1 Line Au PTFE had the biggest difference between the Treatment and Control at 3.42 GHz for all except the 2 plaques panel, which was at 3.41 GHz; the 3 pr Au PTFE sensor had the largest difference at 11.5 GHz for all the panels; the 9 pr Au PTFE sensor detected the biggest difference at 4.73 GHz for all except the 12 plaques panel; and the 2×3 pr sensor had the biggest difference between the Treatment and Control at 1.61 GHz (FIG. 8).

Demonstrated are differences in the Reflection Coefficient output between the Wet and Dry conditions. The 1 line Au PTFE sensor showed differences in the Reflection Coefficient output, particularly at higher frequencies in the Wet condition indicating the sensor's ability to detect the presence of the artificial seawater beyond the PVC panel. However, in the Dry condition the output Reflection Coefficient showed little variance among the different number of byssal plaques on the PVC panels investigated. This may be due to the lack of seawater as well as the position of the plaques relative to the single electrode as they may not be directly over the reduced sensing area resulting in no clear difference between the panels investigated.

The 3 pr, 9 pr and 2×3 pr Au PTFE sensors showed differences in the Reflection Coefficient output between the Wet and Dry conditions as well as between the PVC panels investigated. This demonstrated that these sensors are able to detect not only the presence of the artificial seawater on the surface, but also the byssal plaques. This may be due to the increased number of electrodes that results in an increased sensing area as well as sensing capacity.

The different electrode configurations demonstrated that the quality of sensing of mussel plaques depends on the electrode configuration under seawater conditions. The electrode configurations 3 pr, 9 pr and 2×3 pr Au PTFE sensors were able to detect the mussel plaques and may evidence the positive effect of the electrode finger geometry on sensitivity, particular for 9 pr and 2×3 pr electrodes.

The Impact of Orientation on the Detection of M. edulis Plaques With Four EMW Sensors With Varying IDE Geometries

The Treatment panel from Tank I had 32 plaques, Tank II had a Treatment panel with 18 plaques and Tank III had two panels with 6 plaques and 5 plaques. The largest difference was then deduced between the mean Reflection Coefficient of the Treatment and the Control for each Orientation and the corresponding frequency recorded (FIG. 8). FIG. 8: The Frequency identified where the largest difference between each Reflection Coefficient of the Treatment and the Control occurred for all the sensors in the Initial detection Wet condition and at each Orientation.

There was no effect of the orientation of the electrodes on the output of the sensor for the 1 line Au PTFE and 9 pr Au PTFE sensors. Differences in outputs due to orientation of the 3 pr AU and 2×3 pr Au PTFE sensors.

Efficacy of Varying Sensing Materials for Detecting M. edulis Plaque on a Surface With the Selected EMW Sensor

The sensing quality of the 9 pr Au PTFE sensor was impacted by substratum. The mussel plaque detection was best for Nylon 6, followed on by Silicone, PVC and PTFE. Nylon 6 has the highest permittivity and PTFE and lowest permittivity and this may be the reason why the mussel plaques are identified best on the material Nylon 6. Additionally, the change in the adhesive compounds of the mussel plaques on Nylon 6 may impact the sensing quality, in this case positively.

The results showed that whilst there was a difference in the byssal plaques put down by M. edulis between the four materials, all four materials had detectable plaques. The higher surface energy of Nylon 6 and PVC may result in an increased number of byssal plaques when compared to the lower surface energy of PTFE and Silicone.

The differing materials demonstrated an effect on the efficacy of the 9 pr Au PTFE sensor to detect the presence of mussel byssal plaques on the surface. By considering the output Reflection Coefficient, standard error and the previous finding that the presence of the mussel plaque may decrease the overall relative permittivity resulting in a less negative reflection coefficient, allowed for an appropriate frequency selectivity. the biggest difference between the mean Reflection Coefficient of Treatment and Control was the largest for Nylon 6, followed by Silicone, PVC and PTFE. The large difference seen with Nylon 6 may in part be due to the higher average number of byssal plaques on the surface, however, this did not differ from the average number of byssal plaques obtained with PVC and PTFE, both of which demonstrated a smaller difference. Similarly there was no difference in the average number of byssal plaques between Silicone, PVC and PTFE, and yet Silicone demonstrated a difference in the Reflection Coefficient over three times greater than that of PVC and PTFE. Furthermore, the larger difference in the Reflection Coefficient for Nylon 6 compared to Silicone may be due to their relative permittivities in addition to the difference in the number of byssal plaques. The higher relative permittivities of Nylon 6 and Silicone may allow for a greater reduction in the wavelength to sufficiently allow for effective detection of M. edulis byssal plaques.

Furthermore, possible differences in the plaque size as well as the relative permittivity may also contribute to changes in the Reflection Coefficient as was similarly used to detect and evaluate disbanding and delamination events in dielectric layers based on thickness and relative permittivity.

Here, particularly the 9 pr Au PTFE sensor was able to detect the presence of M. edulis plaque on the surface of Nylon 6 and Silicone by successfully distinguishing between the presence of byssal plaque and the lack of. The overall high biological replicate numbers and analysis meant that differences in plaque numbers per sample, their size, composition and placement may be negated.

These studies highlight the effect of IDE numbers and geometry on sensing capacity of the planar EMW sensors. Particularly, the 9 pr Au PTFE sensor was not impacted by the Orientation of the panels nor the placement of the M. edulis byssal plaques. Furthermore, the non-specific surface capacity of the 9 pr Au PTFE sensor allowed it to function with the Nylon 6, Silicone and PVC whereby detection of M. edulis byssal plaques on the surface was possible.

### Example 2

### Second Set of Experiments

### Study Site

Queens Dock situated in Liverpool, UK was designed by Henry Berry and opened in 1795 as part of the Port of Liverpool was the study site. The field study was conducted at Liverpool Watersports Centre (53°23′33.9″N 2°59′07.6″W) in Liverpool, UK, on 15 Jul. 2019. The selected site was situated on a slipway located to the east of the Watersports Centre. The biofouling community underneath the Liverpool Watersports centre pontoons was where the M. edulis specimens were collected for all testing over the course of the present study and were therefore from the same habitat that the sensory surface was tested.

### Efficacy of the 8 Pair Gold Interdigitated Electrode Sensor of PVDF

Two 8 pr Au PVDF (polyvinylidene difluoride) sensors were used. In order to ensure that the 8 pr Au PVDF sensor was able to perform in a similar manner to the 9 pr Au PTFE sensor, a small-scale laboratory test was conducted with both a Silicone Microtopography and a Smooth Silicone panel.

A test experiment was conducted to ensure that this sensor worked comparative to the 9 pr Au PTFE sensor used in the EXAMPLE 1 section.

### Antifouling Sensory Surface Production for In Situ Use

To produce the antifouling sensory surface for the field, the 8 pr Au PVDF sensor and Silicone surface (with the V40 H150 Antifouling Microtopography and the Smooth Silicone) were combined and waterproofed. The sensors were fully enclosed in Thomtastic 30 (T30) Silicone mix (Thomson Brothers Ltd.) with a 10:1 (w/w) base to curing agent ratio. In order to obtain a sensory surface with an exact 1 mm Silicone thickness over the electrodes with either the Microtopography surface or the Smooth surface, a novel and unique mould was developed using SolidWorks® (Solid Solutions). The mould was then printed using the Chemson Ltd. Original Prusa 13 MK2 3D printer. The mould allowed for the 8 pr Au PVDF sensor, the RF coaxial SMA connector and the V40 H150 laser textured or non-textured marine grade stainless steel coupons (50×50 mm; see Chapter 3) to fit together for the Silicone pour. Silicone mix (see Chapter 2) was poured into part A of the mould. Part B and the stainless steel coupon were then placed onto Part A and carefully placed upright (a laser textured coupon for the V40 H150 Microtopography and Smooth Surface steel coupons with no microtopography). The 8 pr Au PVDF sensor was then pushed into the mould into the correct position with the connector sat at the top. Rubber bands were used to hold the two halves of the mould together, with extra silicone poured at the top to ensure full coverage and left to cure for 48 hours. After 48 hours the sensory surfaces were carefully removed from the moulds; one Sensory Surface with the V40 H150 Antifouling Microtopography and the other with a Smooth Surface. The connection between a RG316 1.5 metre coaxial cable and the soldered female SMA, straight jack connector was lastly waterproofed using self-amalgamating tape. In order to ensure the electrical components were sufficiently waterproofed, the self-amalgamating tape was wrapped around the base of the sensor as well, ensuring it did not cover the electrodes.

### Experimental Setup

The field site was located as described above. The VNA was able to run from 9 kHz to 13 GHz, however, the frequencies of interest were from 3 GHz to 5 GHz. An experimental rig was used. The sensory surface was then connected via a radio frequency (RF) coaxial, SubMiniture version A (SMA), straight jack (50 ohm) connector to a 1.5 metre RF coaxial cable which in turn was connected to another 3 metre RF coaxial cable with a female to female adaptor. M. edulis specimens were collected from the pontoon at the Watersports Centre (4.8 to 5.9 cm in length) and loosely secured to the sensory surface with a cable tie. Each sensory surface, V40 H150 Sensory Surface and the Smooth Sensory Surface, was exposed to a different individual M. edulis (n=1) for 45 minutes and 30 minutes, respectively.

### Data Collection

### Efficacy of 8 Pair Gold Interdigitated Electrode Sensor of PVDF

Laboratory panels were visually examined and the number of byssal plaques on the surface recorded. Measurements were recorded on a VNA (Rohde & Schwarz ZVA24) calibrated from 10 MHz to 15 GHz with 60,000 points as S11 scattering parameter (S parameter) of the reflected signal in a temperature controlled (21° C.) sensor laboratory. The data collected included the air spectrum of the VNA, the additional coaxial cable, the 9 pr Au PTFE sensor and the 8 pr Au PVDF sensor (all plotted using MATLAB (version R2019b). Samples were measured with 400 ul of 28 psu artificial seawater added to the FR4 well and 3 repeat measurements taken of each of the four orientations with the 8 pr AU PVDF sensor.

### Efficacy of the Antifouling Sensory Surface In Situ and in Real-Time

For the field study, the VNA was firstly calibrated from 3 GHz to 5 GHz and a 4000 data points sweep run (10 measurements at 3 GHz and 5 GHz, and 20 measurements at each frequency in between at 10 MHz increments) and recorded as real and imaginary numbers with a time stamp. The M. edulis specimen was placed on the sensory surface, the behaviour observed and recorded. Multiple repeat measurements were taken of the Sensory Surface in the docks alone, with the mussel and then with the byssi only (between 1 and 21).

### Analysis

### Efficacy of 8 Pair Gold Interdigitated Electrode Sensor of PVDF

The mean Reflection Coefficient S11 dB was calculated per panel (all 4 orientations) and graphically represented. The largest difference in the mean (multiple measurements of the same surface) Reflection Coefficient of the Treatments (with byssi) and the Control (no byssi) allowed a single frequency to be deduced where detection was occurring. This was done with both the V40 H150 Silicone Antifouling Microtopography and the Smooth Silicone Panel.

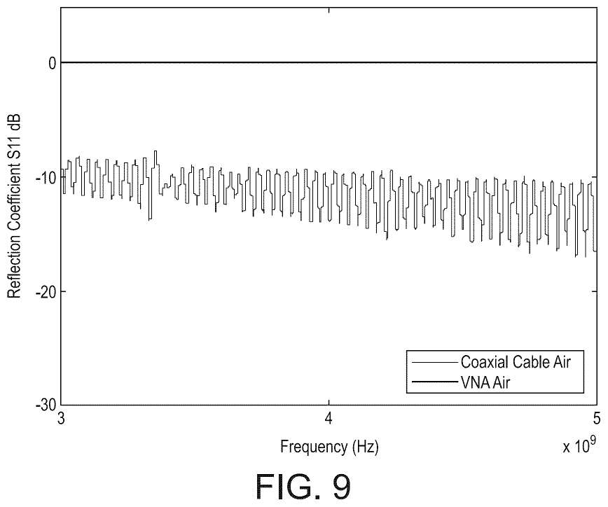

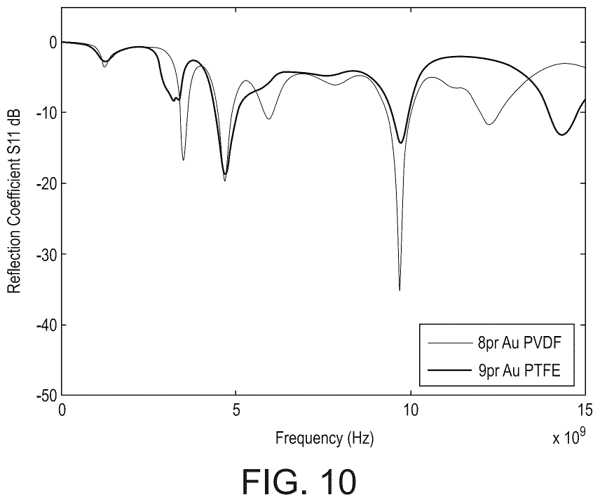

The air spectrums were visualised for the effect of the additional coaxial cable compared to the VNA alone (FIG. 9) as well as for the difference in the air spectrum with the 8 pr Au PVDF sensor and the 9 pr Au PTFE sensor (FIG. 10).

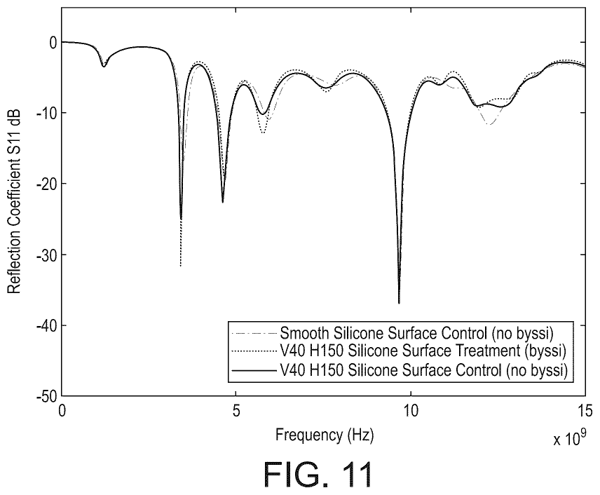

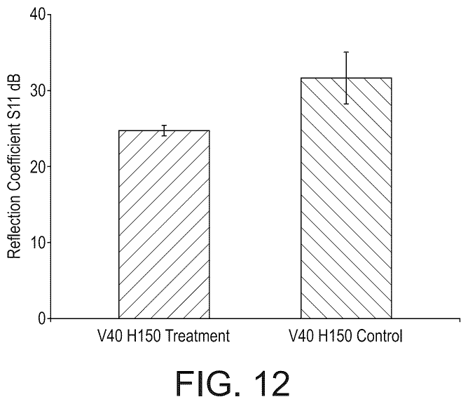

The V40 H150 Antifouling Microtopography Treatment panel was found to have 1 byssus present on the surface while the Smooth Sensory Surface Treatment did not have any byssi present and could therefore not be analysed towards presence of byssi, nevertheless this was graphically represented (FIG. 11). The biggest difference between the Treatment (byssi present) and Control (byssi absent) of the V40 H150 Antifouling Microtopography surface was at 3.43 GHz, with a difference of 6.87 dB and was graphically represented (FIG. 12).

The 8 pr Au PVDF had an effect on the Reflection Coefficient with air when compared to the 9 pr Au PTFE sensor. The air spectrum of the two sensors demonstrated similar outputs, particularly at lower frequencies (f≤5 GHz) whereby the second peak, approximately between 3 GHz and 4 GHz, showed an increased Reflection Coefficient for the 8 pr Au PVDF sensor. The electrodes of the two sensor types was gold and both PTFE and PVDF are fluoropolymers that are widely used as a substrate for various sensor types. the differences in the output between the two sensors may be due to differences in the number of electrodes present resulting in the 8 pr Au PVDF having a slightly decreased sensing capacity. Nonetheless, with a difference of only 1 pair of electrodes, this discrepancy was considered negligible and the similar output frequency allowed for the presumption that the 8 pr Au PVDF may detect the presence M. edulis byssal plaque on a surface as effectively as the 9 pr Au PTFE sensor.

There was an effect on the Reflection Coefficient output by the V40 H150 Silicone Microtopography with 1 byssus (Treatment) and with no byssi (Control) whereby the biggest difference was at 3.43 GHz of 6.87 dB. The larger 6.87 dB compared to EXAMPLE 1 is attributed to the single replicate in this study yielding a large difference in comparison to the 40 replicates investigated previously, or due to the different substrates used for the adhesion of the byssi.

It was demonstrated in a field experiment that the sensors described herein can detect biofouling.

Although embodiments of the present invention have been described in the preceding paragraphs with reference to various examples, it should be appreciated that modifications to the examples given can be made without departing from the scope of the invention as claimed. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not. Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A sensing device configured for use in detecting biofouling adhered to a substrate, the device comprising a sensing component comprising:
an electromagnetic wave sensor,
the substrate
wherein the electromagnetic wave sensor is able to detect biofouling on the substrate.

2. The sensing device of claim 1, wherein the electromagnetic wave sensor is planar.

3. The sensing device of claim 1, wherein the electromagnetic wave sensor is coupled to the substrate so as to be able to detect biofouling on the substrate or is on or embedded in the substrate so as to be able to detect biofouling on the substrate.

4. The sensing device of claim 1, wherein the electromagnetic wave sensor comprises at least one electrode, or wherein the electromagnetic wave sensor comprises a plurality of electrodes arranged in an interdigitated electrode array.

5. (canceled)

6. The sensing device of claim 4, wherein the interdigitated array comprises at least one pair of fingers, or wherein the interdigitated array comprises at least three pairs of fingers, or wherein the interdigitated array comprises at least two separated sets of three pairs of fingers, or wherein the interdigitated array comprises at least eight pairs of fingers or at least nine pairs of fingers.

7. (canceled)

8. (canceled)

9. (canceled)

10. The sensing device of claim 3, wherein at least one electrode comprises gold.

11. The sensing device of claim 1, wherein the substrate is non-metallic, preferably wherein the substrate comprises polyvinylidene difluoride, polycaprolactam, silicone, polyvinyl chloride, and/or polytetrafluoroethylene.

12. The sensing device of claim 1, wherein the electromagnetic wave sensor is configured to operate in a frequency range of about 1.5 to 7 GHz.

13. The sensing device of claim 1, wherein the electromagnetic wave sensor is located on or embedded in the opposite surface of the substrate to the surface of the substrate on which the biofouling will occur, preferably wherein in the device the electromagnetic wave sensor is not exposed to any water or biofouling.

14. The sensing device of claim 1, wherein the substate is at least 0.1 mm thick, preferably wherein the substate is between 0.1 mm and 5 mm.

15. The sensing device of claim 1, wherein the sensing device further comprises:
circuitry for generating a microwave signal to transmit to the electromagnetic wave sensor, preferably wherein the signal is in a frequency range of about 1.5 to 7 GHz; or
a detector to detect a reflected microwave signal frequency from the sensing component; or
a controller to compute the reflected microwave signal frequency from the substrate and calculate a level of biofouling on the substrate or percentage of biofouling of the sensed area.

16. (canceled)

17. (canceled)

18. (canceled)

19. The sensing device of claim 1, wherein, the device is coupled to or is part of something on which biofouling may occur, preferably the something on which biofouling may occur is a sea vessel, boat, submarine, ship, underwater cable, oil rig, platform, buoy, fishing net or fishing apparatus, underwater structure, energy generator, pipeline, waste water processing facility, telecom apparatus, marine instrument, underwater recording apparatus, aquaculture infrastructure and equipment, monitoring stations and equipment, cables, link stations, ROV, AUV and other offshore/onshore structure, infrastructure and equipment in seawater, wastewater, or freshwater, or any part of these.

20. The sensing device of claim 1, wherein the sensing device is located in, attached to, or coupled to a sea vessel's water inlet, sea chest, ballast, or ballast water tank and inlet.

21. (canceled)

22. A method of detecting biofouling, the method comprising:
a. providing the sensor of claim 1;
b. transmitting a microwave signal to the electromagnetic wave sensor;
c. receiving the reflected microwave signal from the sensing component;
d. calculating or detecting any change in the reflected microwave signal from the sensing component; and
e. indicating if there has been any change in the reflected microwave signal from the sensor, wherein a change in the reflected microwave signal from the sensor may be an indication of biofouling on the substrate.

23. The method of claim 22, wherein the method further comprises, prior to step b., generating a microwave signal, preferably wherein the signal is in a frequency range of about 1.5 to 7 GHz, and the method further comprises using a vector network analyser to generate the microwave signal and to receive the reflected signal from the electromagnetic wave sensor representing a measurement performed by the sensor.

24. (canceled)

25. The method of claim 22, wherein the method comprises visually displaying the indication of biofouling.

26. The method of claim 22, wherein detecting biofouling comprises detecting a level of biofouling or percentage of biofouling of the sensed area.

27. The method of claim 22, wherein the method takes places in situ in a marine environment or an environment where biofouling may occur, or the method takes places before a substrate is to be placed in a marine environment or an environment where biofouling may occur, or the method takes place after a substrate has been placed in a marine environment or an environment where biofouling may occur.

28. A method of manufacturing a sensing device for detecting biofouling, the method comprising: enclosing an electromagnetic wave sensor in silicone using a mould.

29. The method of claim 28, further comprising pouring silicone into a first part of the mould, arranging a second part of the mould to enclose the silicone, and pushing the electromagnetic wave sensor into the silicone through a remaining gap in the mould or further comprising placing a coupon etched with a microtopography onto the poured silicone prior to arranging the second part of the mould.

30. (canceled)
